(19) United States
(12) Patent Application Publication
(10) Pub. No.: US 2008/0295093 A1
(43) Pub. Date: Nov. 27, 2008

(54) Method and Module for Dynamic Hosting of Software Applications in a Gateway Between an Operator Network and a Local Area Network

(76) Inventors: Cedric Hutchings, Levallois (FR); Clement Moreau, Paris (FR); Eric Carreel, Meudon (FR)

Correspondence Address: Joseph J. Laks;Thomson Licensing LLC, 2 Independence Way, Patent Operations, PO Box 5312, PRINCETON, NJ, 08543, US

(21) Appl. No.: 11/629,115

(22) PCT Filed: Jun. 8, 2005
(86) PCT No.: PCT/FR05/01414

§ 371 Date: Dec. 8, 2006

(30) Foreign Application Priority Data
Jun. 9, 2004 (FR) 0406244

(51) Int. Cl. G06F 9/445

(52) U.S. Cl. 717/178

(57) ABSTRACT

A method for dynamic hosting of software applications in a system comprising local area networks and an operator network delivering services to users, wherein each local network comprises user terminals and a gateway which is connected to the operator network, establishing a communication channel between the network operator and the user upon request from the user of a terminal, enabling the user to access the services delivered, wherein the gateway is devoid of a user interface to access services and comprises a volatile memory and a non-volatile memory, comprising a downloading step during which a software application is at least partially downloaded and at least one part of the downloaded software application is stored in the volatile memory of the gateway, wherein at least one part of the downloaded software application in the volatile memory is not downloaded to the non-volatile memory.

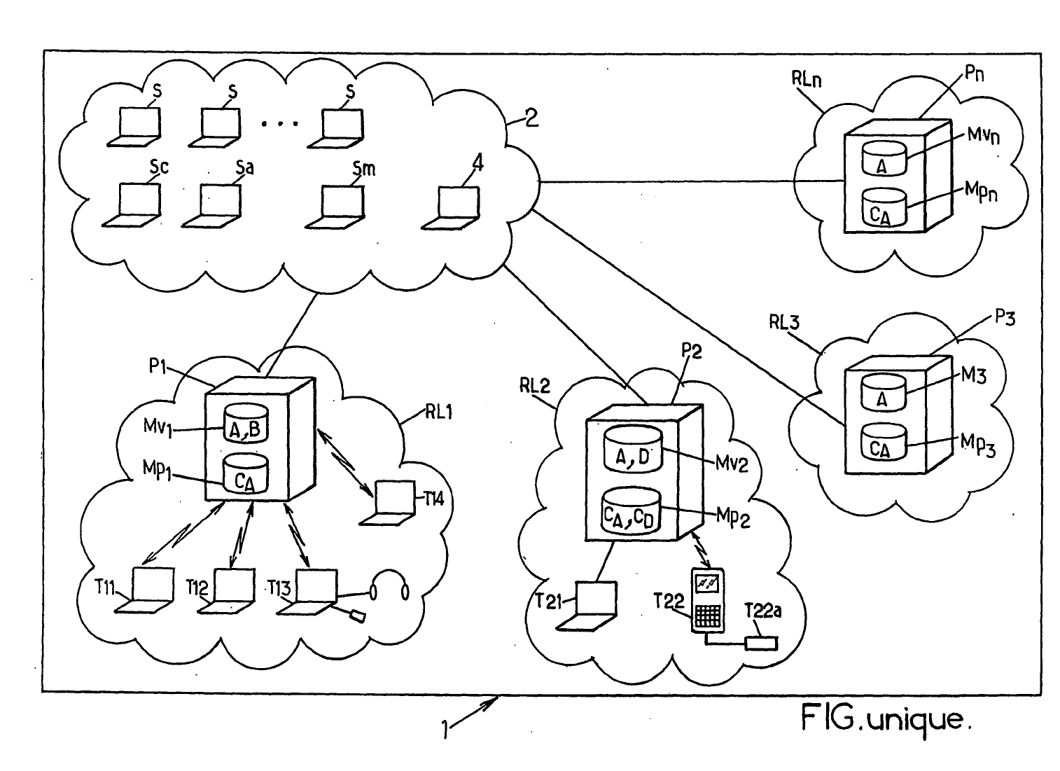

The present invention relates to the domain of systems comprising the network of an operator and terminals. The operator's network delivers services to subscribers. The subscribers have access to these services from user interfaces with which the terminals are fitted.

The services provided by the operator are for example TV broadcasting, voice over IP, Internet navigation, etc.

More specifically, the present invention deals with cases in which a gateway device is situated between the operator's network and the terminal or terminals of a same subscriber. For example, for a same subscriber, two fixed PCs (personal computer), a mobile computer, a PDA (Personal Digital Assistant) are connected via a local area network to the gateway device.

Upon a request from the user for access to the services provided by the operator that is set up from the user interface of the terminal operated by the user, the gateway device sets up a communication channel between the operator network and the user, by which channel the user has access to the services.

The gateway device is not provided with a user interface enabling the services supplied by the operator to be used by user. This use is solely from the user interfaces of the terminals.

Such a gateway device comprises memories capable of storing the software applications run in the gateway device.

Some of these software applications stored may have been loaded at the factory or during the initial configuration of the gateway device. Others may have been downloaded from the operator network, then stored in the getaway device.

In the prior art, the software applications stored and run in the gateway device are stored in the non-volatile memory of the device.

However, the permanent data storage components constitute a significant entry in the cost of the device.

The present invention proposes a method and a module designed to reduce this disadvantage.

Hence, according to a first purpose, the present invention proposes a dynamic hosting process for software applications in a system comprising at least one local area network and an operator network delivering services to the users.

Each local area network comprises at least one terminal with a user interface, which enables the communication with a user of the said terminal. Each local area network also comprises a gateway device connected to the network of the operator and setting up, upon the request of the user of a terminal in the said local area network, a communication channel between the network of the operator and the user. The communication channel thus set up enables the user to access the services provided on the operator's network. The gateway device is not provided with a user interface for access to the said services and comprises a set of software applications.

The method comprises at least one downloading step during which a software application is at least partially downloaded and at least one part of the downloaded software application is stored in the volatile memory of the gateway device of a local area network. At least one part of the software application downloaded into the volatile memory is not downloaded into the non-volatile memory and is thus stored exclusively in the volatile memory.

A method according to the invention thus reduces the number of components used to store software applications in the non-volatile memory of the gateway device, and therefore reduces the cost. Other advantages will be described subsequently.

The software application or the part of software application thus downloaded is then run from the corresponding data stored in volatile memory.

In the embodiments of the invention, the method also comprises one or other of the following arrangements:
the software application resides solely in the volatile memory or the gateway device,
in the non-volatile memory, a parameter indicative of the software application downloaded is also stored in the volatile memory of the gateway device,
at least one part of a software application is downloaded in response to a request from the user of a terminal in the local area network,
at least one part of a software application is downloaded in response to a request from the operator,
the downloading is carried out following the connection of a new item of equipment to the local area network.

According to a second purpose, the invention proposes a dynamic hosting module for software applications comprising means to implement a method according to the first aspect of the invention.

Other characteristics and advantages of the invention will emerge from reading the following description. The description is purely illustrative and must be read in relation to the annexed drawings wherein:

the single FIGURE shows a system in an implementation mode of the invention.

In reference to the single FIGURE, a system 1 comprises the network 2 of a service operator delivering different services to its subscribers in accordance with the options chosen by these subscribers. Among the services proposed are Internet navigation packages (10 hours/month, unlimited), a voice over IP service, a video on demand service, a music broadcasting service, a digital photo management service, etc.

The network 2 of the operator comprises many communications servers S adapted to provide all the services. It also comprises application servers Sa, file configuration servers Sc and messaging servers Sm.

The operator provides services to many subscribers. Each subscriber has a local area network RL. A local area network RL comprises a gateway P and at least one user terminal T communicating with the gateway.

The gateway P of a local area network has a link with the operator network 2. This link allows exchanges between the operator network 2 and the gateway P of a local area network and contributes to the supply of services to the subscriber.

Moreover, the operator network 2 comprises a consultation server 4 with which the gateways P1 . . . Pn are in regular contact. This consultation allows the operator network 2 to provide the gateways regularly with instructions relating to the loading of software applications by the application server Sa, to the configuration modifications to be performed by the configuration server, etc. required for the correct operation of the network 2

Each gateway P has a volatile memory capacity Mv and a permanent memory capacity Mp.

A volatile memory is called so, such that the data stored is lost when the power supply is interrupted, for example after the gateway is switched off by a user. The data stored in a permanent memory will remain, barring a deliberate action aiming to remove this data.

A certain amount of software data is stored in these respective memories.

Configuration data defining, among other things, the ownership of the gateway (owned by the operator or the subscriber), the profile of the subscriber and generally governing the behaviour of the gateway during connections with the consultation server 4, according to the content found on this server, are also stored in the permanent memory Mp. The configuration servers Sc update these configuration files from the operator's network 2.

The gateway P of a local area network is, moreover, linked to each terminal in the local area network.

At least some of the user terminals are equipped with a user interface. A user of a local area network requires, by means of the user interface of a terminal, access to a subscribed service. In response to this request, exchanges in relation to the verification of the rights of the subscriber occur between the gateway P and the operator network 2, then if necessary, the gateway P sets up a communication channel between the subscriber and the network 2, enabling the required service to be provided for the user.

In the single FIGURE, the local area networks RL₁, RL₂ . . . RLₙ of n subscribers is shown. Each local network RLᵢ has k terminals Tijᵢⱼ=1 to k and a gateway Pᵢ with a volatile memory Mvi and a permanent memory Mpi.

The RL1 network comprises four terminals T11, T12, T13 and T14. The network RL1 also has the gateway P1. The terminal T11 is a fixed PC, the terminal T12 is a mobile computer, the terminal T13 is a PC with headphones and a microphone. The terminal T14 is a printer. The subscriber corresponding to the local area network RL1 has Internet navigation and telephony services provided by the operator of the network 2.

The gateway P1 comprises a volatile memory Mv1 and a permanent memory Mp1.

It is connected to each of the terminals with a Wi-Fi link for example.

The network RL2 has two terminals T21 and T22 and a gateway P2. The terminal T21 is for example a fixed PC. The terminal T22 is a PDA.

The PC T21 is for example connected to the gateway P2 by a wire link, whereas the PDA T22 is connected to the gateway P2 with a Bluetooth connection.

The gateway P2 comprises a volatile memory Mv2 and a permanent memory Mp2.

In one embodiment of the invention, the operator of the network 2 wants to introduce, for a set period of time T, a new service S to its subscribers. The consultation of this new service assumes the execution of a new software application A on the gateway.

Hence, following the connections initiated by the gateways P1, P2, . . . Pn to the consultation server 4 of the network 2 (for example, of the https type), the application A is downloaded from the application server Sa to these gateways.

The application A, as well as the data relating to the activation of this application (notably in relation to the period T) are stored in the volatile memory Mvi of each gateway Pi. So when, for example, a user runs the consultation of the new service S from the terminal T11, the application A will be executed on the gateway from the corresponding data stored in volatile memory Mv1. This data will be lost when the gateway is shutdown.

For the entire period T of this introductory operation proposed by the operator, the application A will thus be stored in the volatile memory of the gateways connected to the network 2 and can be activated upon the request of a user for access to the service S from a terminal of the local network.

In one particular embodiment, during the first download operation of the software application A, a field CA is set in the non-volatile memory Mp of each gateway, in such a manner as to start the download of the application A automatically after the gateway is started up during the period T. This arrangement notably has the advantage of making the application immediately available, without waiting for the exchanges of the gateway with the configuration server 4, then with the different servers of the network, to occur following a consultation initiated by the gateway.

In one mode of implementation of the invention, a user can activate the downloading. For example, when a user of the terminal T13 selects the Voice over IP service, he causes the application B required to implement this service to be downloaded from the network to the gateway P1 and to be stored in the volatile memory Mv1.

In one mode of implementation, the downloading and storage in the volatile memory of an application can be triggered simply by connecting an item of peripheral equipment.

Hence, the connection of an unknown digital camera T22a, by a user of the RL2 network, to its PDA T11 will cause the search, then the downloading to the memory MV2, of the corresponding driver program D, if this program is available. These are the exchanges initiated by the gateway P2 with the consultation server 4, then with the other servers of the network 2 according to the instructions given to the gateway P2 by the consultation server 4 that will enable this download operation to be set up.

A field C_{D} is also set in the memory Mp2, enabling the downloading of the application D into the memory Mv2 to be started automatically when the gateway P2 is started up after detection of the presence of the T22a peripheral device.

In the aforementioned examples, the entire software application considered was stored in the volatile memory exclusively.

In particular modes of implementation, an application is downloaded, but only a first part of a software application is stored exclusively in the volatile memory of a terminal, the other part being stored in the permanent memory (possibly in addition to temporary storage in the volatile memory).

In particular modes of implementation, only one first part of a software application is downloaded into the volatile memory of a terminal, the other part being contained beforehand in the permanent memory.

For example, the major part of an application can have been stored beforehand (in the factory or on initial installation by the operator of the gateway at the subscribers or by previous downloading) in the permanent memory Mp of one or more gateways, the remainder of the application only being supplied by downloading from the gateway of a subscriber and stored in the volatile memory Mv of this gateway after the subscriber subscribes to the corresponding service with the operator.

Hence, the present invention enables users to be provided with software applications (or parts of applications) in response to requests from the operator and/or the local area network of the subscriber. These applications are stored in volatile memory and thus enable the cost due to the permanent storage of data to be reduced. They have the advantage of being run on the gateway, hence in a manner closer to the final user, and ensure reduced interaction times. The invention, by reducing the cost related to the supply of applications by downloading, also enables an easier updating of the software applications intended for the gateways, thus enables a homogenous set of gateways to be maintained easily in software terms.

1-7. (canceled)

8. Communication device comprising access means to an operator's network and access means to a local area network (to which at least one terminal is connected, the said communication device comprising a volatile memory and a non-volatile memory,
the said communication device being wherein it comprises:
means for at least partially receiving a software application through downloading;
storage means in its volatile memory of at least one part of the downloaded software application, such that at least one part of a software application downloaded into its volatile memory is not downloaded into its non-volatile memory, and
means for running an application downloaded following a request for access to an associated service coming from a local area network terminal.

9. Communication device according to claim 1, wherein the said software application resides exclusively in the volatile memory of the said device.

10. Communication device according to claim 1, wherein it comprises a means for storing in its non-volatile memory a parameter indicative of a software application downloaded into the volatile memory of the said device.

11. Communication device according to claim 1, wherein the downloading is realized in response to a request from a user of a terminal in the local network.

12. Communication device according to claim 1, wherein the downloading is realized in response to a request from the operator.

13. Communication device according to claim 1, wherein the downloading is realized after the connection of a new item of equipment to the local area network.
